(19) United States
(12) Patent Application Publication
(10) Pub. No.: US 2018/0155856 A1
(43) Pub. Date: Jun. 7, 2018

(54) SINGLE-PLY TEXTILE SUPPORT AND REINFORCING MATERIAL

(71) Applicant: GEBRÜDER OTTO BAUMWOLLFEINZWIRNEREI GMBH & CO. KG, Dietenheim (DE)

(72) Inventor: Andreas MERKEL, Dietenheim (DE)

(21) Appl. No.: 15/577,003

(22) PCT Filed: May 30, 2016
(86) PCT No.: PCT/EP2016/062107

§ 371 Date: Nov. 27, 2017

(30) Foreign Application Priority Data
Jun. 2, 2015 (DE) 10 2015 108 686.7

(51) Int. Cl. D02G 3/26; D04B 1/02

(52) U.S. Cl. CPC D02G 3/26; F16L 11/08; D04B 1/025

(57) ABSTRACT

The invention relates to a single-ply textile support and reinforcing material (20) for articles made of rubber and/or plastic, in particular for hoses and composite materials, which is formed by means of spun yarns with very low yarn rotation (spin alpha 0-10) or completely without yarn rotation preferably for knitted fabrics. The invention also relates to articles made of rubber and/or plastic, in particular hoses and composite materials, which contain the textile support and reinforcing material.

### BACKGROUND OF THE INVENTION

### 1. Field of the Invention

The invention relates to a single-ply textile support and reinforcing material for articles made of rubber and/or plastic, in particular for hoses and composite materials.

### 2. Description of Related Art

Textile materials are usually used in particular in the rubber industry to reinforce the rubber matrix. Depending on the requirements of the product to be produced, these materials can consist of steel fibres, natural or synthetic fibres or glass fibres. The textile materials can be filaments or yarns or twines made of staple fibres and/or filaments, but preferably sheet materials in the form of fabrics, knitted fabrics, crocheted fabrics, non-woven materials, nettings or scrims. To produce the finished article, the support material is bonded to the rubber or plastic material by vulcanization or curing. An essential feature of these reinforcing materials is a low tendency to burst, to make them durably dimensionally stable.

DE 2829387 A1 describes two-component textile materials consisting of a base layer made of a woven, knitted or non-woven substance and, secured thereto, for example by tufting, pile weaving or sliver knitting, a layer made of fibre staples which is to provide good adhesion to reinforcing materials, such as for example resins reinforced with glass fibres.

U.S. Pat. No. 2,303,523 describes interliners for car tires in the form of mats which consist of cotton fibre bands which are joined by means of stitching.

The solutions for textile reinforcements discussed above rely on several plies of a textile sheet, wherein one component of the structure is responsible for the strength and at least one other is responsible for the adhesion to the surrounding matrix. Two-component or two-ply textile reinforcements are also described, for example, in US 2015/0068938A1 and US 2014/0261972A1.

### BRIEF SUMMARY OF THE INVENTION

However, reinforcements produced with two or more components have the disadvantage that, because of the additionally necessary method steps, they require a higher outlay during production than single-ply textiles.

In particular for the bond between the textile support and reinforcing material and the rubber or plastic, the size of the fibre surface area plays an important role, which narrowly correlates to the physical parameter of porosity.

The porosity is defined as the ratio of the void volume of a substance to its total volume.

In the case of textile materials, a distinction is made according to the following pore types:
a) micropores (e.g. inside fibres);
b) macropores (e.g. between fibres or individual filaments);
c) mesopores (e.g. between yarns);
d) gigapores (between sheets or covering layers).

The pore-size distribution can be determined on the basis of the ASTM F 316-80 standard, for example with a Coulter Porometer.

In the case of single-ply knitted fabrics, crocheted fabrics or fabrics made of filaments, mesopores predominate. The porosity and the average value of the pore size are high. The open pore surface is large, and so is the pore depth. Conventional single-ply support materials produced from filaments also have a high strength and a small volume. Because of the smooth filament structure with comparatively small surface area, however, disadvantages result, despite the high porosity in the case of the mesopores, in the adhesion between the support material and the rubber, plastic or the resin.

If the support and reinforcing material, on the other hand, is produced as a knitted fabric, crocheted fabric or fabric made of a yarn spun with high twist (usual values of the twist factor “alpha metric” or also “spin alpha metric” lie between 80 and 180, according to the spinning formula: twist/metre=(spin) alpha (metr.)×(Nm)^{1/2}), or a twine thereof, then a smaller average pore size results than in the case of support materials made of filaments, wherein the porosity is determined by macro- and mesopores. On the other hand, this support material, because of the protruding fibres of the yarn or twine, has a larger surface area for bonding to the rubber matrix or the plastic, with the result that, compared with support materials made of filaments, an overall better bond between the support and reinforcing material and the rubber or plastic results. However, with respect to adhesion and tendency to burst, this material is still not satisfactory for the most demanding applications.

The object of the invention is to create a textile support and reinforcing material for articles made of rubber and/or plastic which, at the same time, has a low tendency to burst due to high resistance to bursting as well as high porosity with reduced average pore size (in particular higher macroporosity and lower mesoporosity compared with standard reinforcing materials made of filaments or yarns with high twist) and thus, along with this, very good adhesion properties to rubber and/or plastic.

The object is achieved by a single-ply textile support and reinforcing material for articles made of rubber and/or plastic, in particular for hoses and composite materials, which is characterized in that it consists of spun yarns which have only very low twists in all areas of the cross section. A very high macroporosity is thereby achieved for optimal fibre-matrix adhesion. Through the high linearity and the high linear fibre-fibre adhesion, such materials have an optimally low tendency to burst. In contrast, in the case of conventional twisted yarns, the fibres are present helically entwined, which can result in an elongation (bursting) in the event of repeated mechanical loading.

Through the very low yarn twist, the high porosity of the textile sheet goods is retained—at the same time the very low twist makes an optimal fibre-fibre friction possible and thereby results in a high strength and significantly improved bursting properties for the textile reinforcements.

Another (functional) filament or multi-filament yarn, which can then be meshed together with the very low-twist fibres, can be added to the fibre assembly produced in this way. In this way, an improved adhesion can be combined with additional strength, temperature stability and/or chemical resistance or other functional properties.

### BRIEF DESCRIPTION OF SEVERAL VIEWS OF THE DRAWING

FIG. 1 shows a microscope image of a support material produced from a yarn according to the state of the art.

FIG. 2 shows a schematic representation of a support material produced from a yarn according to the state of the art.

FIG. 3 shows a microscope image of a support and reinforcing material according to the invention.

FIG. 4 shows a schematic representation of a support and reinforcing material according to the invention.

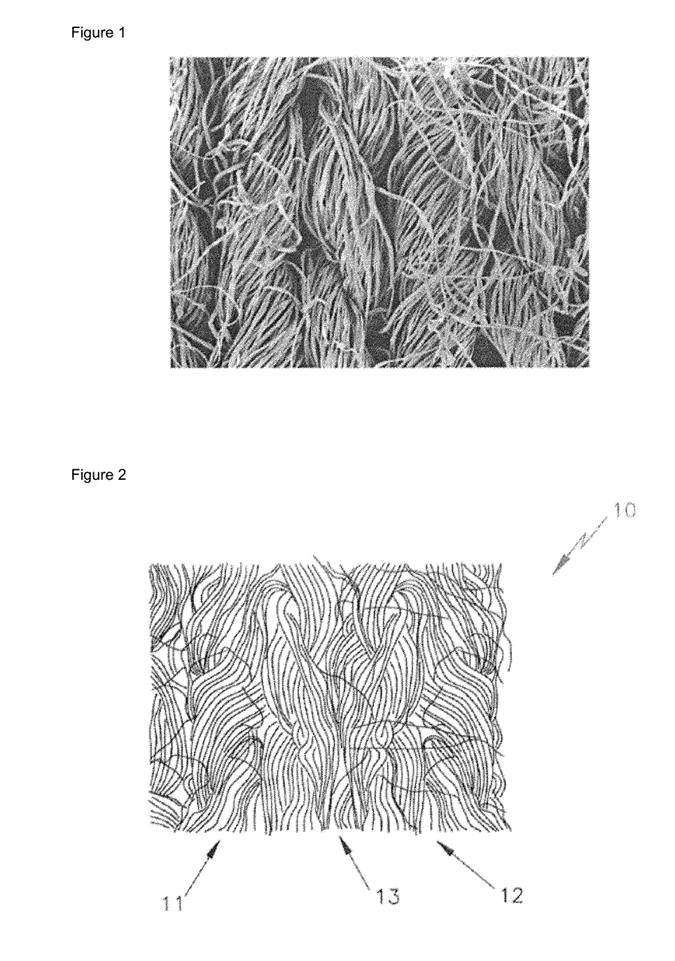

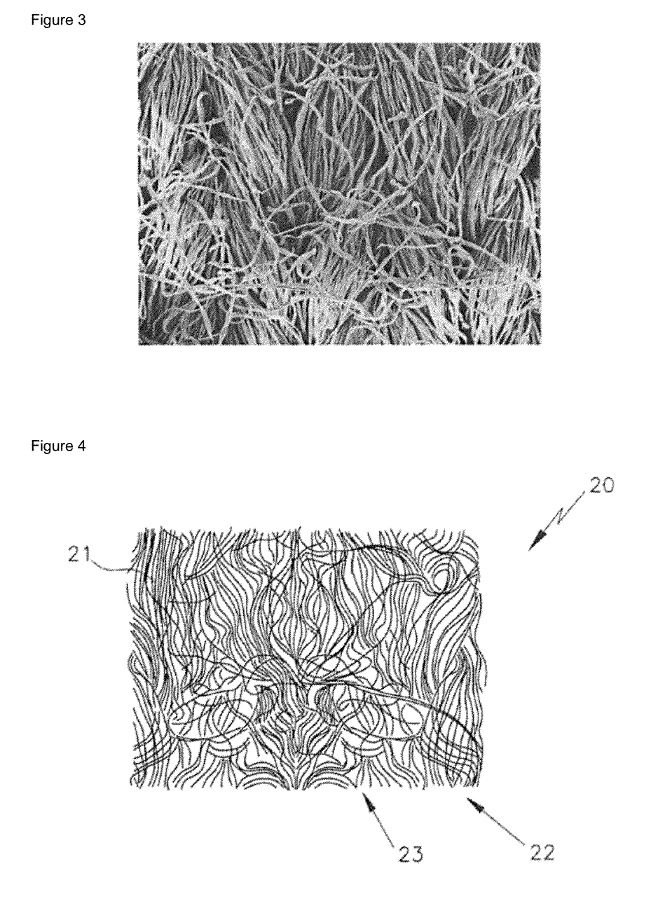

### DETAILED DESCRIPTION OF THE INVENTION

The invention relates to single-ply textile support and reinforcing material for articles made of rubber and/or plastic, in particular for hoses and composite materials. The support material is characterized in that it is a textile sheet material produced from staple fibre yarns with very low twists, wherein the yarns are constructed from staple fibres. The term “low twist” here refers to a spin alpha metric in the range of from 0 to 10. Preferably, the textile support and reinforcing material is a knitted fabric produced from staple fibres by means of a spinning-knitting process, the stitches of which are formed of the very low-twist staple fibre yarns.

In a further embodiment, the invention relates to textile support and reinforcing material for articles made of rubber and/or plastic, in particular for hoses and composite materials, which is characterized in that it is a knitted fabric produced from staple fibres by means of a spinning-knitting process, the stitches of which are formed of the staple fibres spun without twist.

A further part of the invention is the use of the textile support and reinforcing materials according to the invention for articles made of rubber and/or plastic, in particular for hoses and composite materials. The use of a textile support and reinforcing material made of staple fibres is particularly preferred, wherein polyester fibres, polyamide fibres, aramid fibres, para-aramid fibres and fibres with a high resistance at temperatures of 150° C. or higher temperatures and/or a high strength of 50 cN/tex or more are used as staple fibres. The use according to the invention with the features of the claims is further preferred.

Furthermore, the invention relates to articles made of rubber and/or plastic, in particular hoses and composite materials, which contain the textile support and reinforcing materials according to the invention. Articles are particularly preferred in which polyester fibres, polyamide fibres, aramid fibres, para-aramid fibres and fibres with a high resistance at temperatures of 150° C. or higher temperatures and/or a high strength of 50 cN/tex or more are used as staple fibres of the textile support and reinforcing materials according to the invention. The articles according to the invention with the features of the claims are further preferred.

By the term articles made of rubber and/or plastic within the meaning of the present invention is also meant, in particular, mechanically stressed articles made of rubber. These are components made of rubber which are reinforced by (high-performance) fibres to meet their mechanical and thermal requirements in the envisaged field of use.

Examples of articles made of rubber and/or plastic are, in particular, thermally and/or mechanically stressed hoses, for example industrial pneumatic pressure hoses, as well as pressure hoses conveying pressurized gas or liquid, belts, in particular drive belts, conveyor belts or also tarpaulins, all in a very wide variety of technical applications, for example heavy goods vehicle tarpaulins, as well as fibre composite materials which can be provided with the textile support and reinforcing material according to the invention.

The term rubber comprises both natural and synthetic rubber materials. Suitable rubber materials are, for example, natural rubber, styrene-butadiene rubber, ethylene-propylene-diene rubber, butyl rubber, chloroprene rubber, epichlorohydrin rubber, (hydrogenated) nitrile rubber, chlorosulphonated polyethylene, polyurethane rubber, polyacrylate and ethylene acrylate rubber, fluorine rubber, silicone rubber and fluorine silicone.

Plastics for embedding fibres for fibre composite materials comprise composite resin systems, such as for example polyester resins, epoxy resins and vinyl ester resins.

To produce articles made of rubber, the rubber material is calender coated, under pressure, onto the support material and then vulcanized, resulting in an intimate fixing bond and crosslinking.

To produce articles made of plastic, the support material is saturated with the plastic and then cured and crosslinked.

The textile support and reinforcing materials according to the invention contain yarns made of staple fibres. Preferably, the staple fibres are polyester fibres, polyamide fibres, aramid fibres or para-aramid fibres as well as fibres which consist of polymers derived from these chemical fibres or contain mixtures thereof. These fibres have a high strength and/or high temperature resistances.

The staple fibres can also be formed of other technical polymers such as PPS (polyphenylene sulphide), PVA (polyvinyl alcohol), PEEK (polyether ketone), PBI (polybenzimidazole), PAI (polyamide imide), PI (polyimide), PPO (poly-para-phenylene oxadiazol), LCP (polyaromatics) among others, which can be spun to form fibres, provided that the fibres produced therefrom have strengths of 50 cN/tex or more and/or long-term temperature resistances of 150° C. or more.

Depending on the application case, the staple fibres can also partially contain cotton fibres combined with one or more of the above-named staple fibres. Cotton fibres are absorbent and soft and can therefore contribute to a higher flexibility of the material.

In the case of cotton fibres, the staple fibres preferably have a length in the range of from 25 to 40 mm. Aramid or para-aramid fibres preferably have a length in the range of from 30 to 100 mm, more preferably in the range of from 40 to 60 mm, in particular approximately 50 mm.

The above-named advantageous properties can be achieved, for example, by production methods for textiles such as are described in the patent applications WO 2004/079068 or WO 2007/093165, or WO 2007/093166. At the same time yarns with very low twist (spin alpha metric 0-10) are spun and knitted to form knitted fabric at the same time. According to the conventional production method, yarns are usually spun with a much higher twist factor of spin alpha metric 80 to 180.

The textile support and reinforcing materials of the present invention are characterized in that they consist of a knitted product which contains a continuous fibre assembly of staple fibres, in which the staple fibres are arranged either without twist or almost untwisted, i.e. with a very low twist (spin alpha metric in the range of 0-10), and lying substantially parallel to each other. The value for the spin alpha metric preferably lies in the range of 0.05-10, more preferably in the range of 0.1-3 or in the range of 0-2, more preferably in the range of 0.05-1 and in particular in the range of 0.08-0.15.

The support and reinforcing materials according to the invention can, for example, be produced by stretching a fibre assembly of staple fibres formed in the manner of a roving before the stitch formation to the desired yarn count in a stretching machine and then processed in a subsequent further method step to form stitches. The stitching can be effected, for example, with a flat or circular knitting machine, which can be formed as a right/right, right/left or left/left circular knitting machine. Such a method is called, for example, a “Spinit” method (i.e. spinning-knitting method from e.g. Mayer & Cie GmbH & Co. KG.).

Textile support and reinforcing materials without twist denote those materials in which any twists present are unravelled or removed again, for example, on the section between the thread guide or the end of the spinning tube and the knitting point through the so-called false twist effect.

The support and reinforcing material according to the invention has almost exclusively an adhesion of fibre to fibre. This adhesion generates a high resistance, with the result that a lower tendency of the material to deform (burst) results than in the case of conventional support materials. The textile support or reinforcing material according to the invention or used according to the invention has a high dynamic strength.

The textile support and reinforcing materials according to the invention preferably have an average pore size that is at least 10%, more preferably 20%, smaller than that of conventional single-ply knitted fabrics.

The textile support and reinforcing materials according to the invention can be applied to the rubber or plastic both as a raw knitted fabric and as a “ready finished” knitted fabric, i.e. for example washed and dried or dried and fixed.

Because the fibres lie parallel, the porosity of the material according to the invention is differently distributed with respect to the pore size classes compared with a knitted fabric made of a conventional yarn or filament. The average pore size is smaller than in the case of a material produced from a yarn or filament. As far as possible, the porosity is determined by macropores. For example, the water vapour permeability resistance measured using the PERMETEST from SENSORA on the basis of ISO 11092/EN 31092 can be used as a measure of the porosity. Compared with conventional knitted fabrics made of a yarn which is produced with high twists, the support material according to the invention has an approx. 5%-15% higher water vapour permeability resistance. The high macroporosity also promotes the intimate bond between the support and reinforcing material and the rubber or plastic matrix. At the same areal weight, a 5-20% larger volume of the material compared with materials made of yarns or filaments also results. In applications in which a particular volume of the support material is predefined, material savings of 10-20% can thereby be achieved.

Because of the fact that the textile support material according to the invention is designed single-ply, i.e. makes do with one layer system, it is additionally more cost-effective and less resource-intensive compared with systems which, analogously to the state of the art to date, are designed at least two-ply, i.e. function with at least two layer systems.

The sheets produced by means of a spinning-knitting method for reinforcing materials made of rubber or plastic are to be produced particularly economically because of the economized processes of ring spinning and spooling and economized storage of yarns. A saving of between 35% and 58% can be made on CO₂ emissions through the method.

The areal weight of the support and reinforcing material, depending on the later use, can be between 80 and 350 g/m², for example between 80 and 150 g/m², for an application as a reinforcement.

In principle, the support and reinforcing material can be produced on all types of knitting machines. Particular advantages result, however, if it is a hose-shaped material knitted on a circular knitting machine. Circular knitting machines are particularly suitable for carrying out spinning-knitting methods. If the support material is to be used to produce hoses, it can be already knitted in the desired diameter.

Within the framework of the present invention, in particular, combinations of the preferred features are particularly preferred embodiments. Thus, the preferred staple fibre materials are quite particularly preferably to be combined with the further preferred features, such as are indicated in the claims.

The invention is explained in a non-limiting manner using the figures and following examples.

In the schematic representation of a known support material (10) in FIG. 2, stitches (11) which are produced from a conventionally spun yarn can be clearly recognized. The material (10) also contains fibres (12) protruding from the yarn. Large, open pores (13) are to be recognized between the stitches (11).

As FIG. 4 shows, a support and reinforcing material (20) according to the invention has stitches (21) made of fibres (22) lying in parallel, i.e. low-twist. The fibres (22) adhere to each other and enclose a plurality of small, open pores (23) in between. A high strength of the material (20) thereby results, as well as an intimate bond to a rubber, resin or plastic with which it is later bonded by vulcanization or saturation and curing.

### EXAMPLES

### Determination of the Tendency to Burst

The tendency to burst is determined according to ISO 13938:2 1999:

A sample of the textile material is placed on a circular surface covered with a membrane and clamped. The air or liquid pressure acting under the membrane leads to the bulging of the test area and can be steadily increased until the sample bursts. To assess the forces acting in the sample, the bulging or bursting pressure will be measured. The deformations occurring are calculated, among other things, from the bulging heights. The tendency to burst describes the work that is necessary to achieve, in the bulge test, the bulging of the sample until a set bulging pressure or its associated bulge volume is reached.

Table 1 shows the bulging pressure in the case of a bulging height of 30 mm after the 1^{st} and 5^{th} test cycle for examples according to the invention and comparison examples:

| | Pressure after | Pressure after |
|---|---|---|
| | the 1^{st} | the 5^{th} |
| | test cycle in kPa | test cycle in kPa |
| Example 1 (carded Spinit) | 115.2 | 85.1 |
| Example 2 (middle staple Spinit) | 116.9 | 84.2 |
| Comparison example 1 (carded | 89.8 | 68.8 |
| conventional) | | |
| Comparison example 2 | 101.9 | 76.6 |
| (middle staple conventional) | | |

The staple fibres of Example 1 and comparison example 1 have a length of approx. 25-28 mm. The staple fibres of Example 2 and comparison example 2 (middle staple) have a length of approx. 28-30 mm.

The staple fibre yarns of Examples 1 and 2 according to the invention have a twist factor (spin alpha metric) of approx. 0.1. The staple fibre yarns of comparison examples 1 and 2 have a twist factor (spin alpha metric) of from 100 to 110.

It is clear that the textile support and reinforcing materials according to the invention require much higher pressures than the conventional materials to reach a bulging height of 30 mm. The textile support and reinforcing materials to be used according to the invention thus have a much lower tendency to burst.

1-11. (canceled)

12: A support and reinforcing material comprising:
a single-ply of a textile sheet material produced from staple fibre yarns, the staple fibre yarns comprising a twist factor having a spin alpha metric within a range from 0 to 10, wherein the staple fibre yarns are constructed from staple fibres.

13: The support and reinforcing material according to claim 12, wherein the textile sheet material is a knitted fabric produced by subjecting the staple fibres to a spinning-knitting process, the support and reinforcing material further comprising stitching formed of the staple fibre yarns.

14: The support and reinforcing material according to claim 12, wherein the staple fibres are arranged substantially parallel to each other.

15: The support and reinforcing material according to claim 12, wherein the staple fibres comprise polyester fibres, polyamide fibres, aramid fibres or para-aramid fibres.

16: The support and reinforcing material according to claim 12, wherein the staple fibres further comprise cotton fibres.

17: The support and reinforcing material according to claim 12, wherein the textile sheet material has an areal weight within a range from 80 g/m² to 350 g/m².

18: The support and reinforcing material according to claim 12, wherein the textile sheet material is formed in a hose shape.

19: The support and reinforcing material according to claim 12, wherein the spin alpha metric of the twist factor is within a range from 0.05 to 10.

20: The support and reinforcing material according to claim 12, wherein the spin alpha metric of the twist factor is within a range from 0.1 to 3.

21: The support and reinforcing material according to claim 12, wherein the spin alpha metric of the twist factor is within a range from 0 to 2.

22: The support and reinforcing material according to claim 12, wherein the spin alpha metric of the twist factor is within a range from 0.05 to 1.

23: A support and reinforcing material comprising:
a knitted fabric produced from staple fibres by a spinning-knitting process, wherein stitches of the knitted fabric are formed of untwisted staple fibres.

24: The support and reinforcing material according to claim 23, wherein the untwisted staple fibres are arranged substantially parallel to each other.

25: The support and reinforcing material according to claim 23, wherein the staple fibres comprise polyester fibres, polyamide fibres, aramid fibres or para-aramid fibres.

26: The support and reinforcing material according to claim 23, wherein the staple fibres further comprise cotton fibres.

27: The support and reinforcing material according to claim 23, wherein the textile sheet material has an areal weight of 80-350 g/m².

28: The support and reinforcing material according to claim 23, wherein the textile sheet material is formed in a hose-shape.

29: The support and reinforcing material according to claim 23, wherein the staple fibres are formed into staple fibre yarns by the spinning-knitting process, the staple fibre yarns comprising a twist factor having a spin alpha metric within a range from 0.05 to 10.

30: The support and reinforcing material according to claim 23, wherein the staple fibres are formed into staple fibre yarns by the spinning-knitting process, the staple fibre yarns comprising a twist factor having a spin alpha metric within a range from 0.1 to 3.

31: The support and reinforcing material according to claim 23, wherein the staple fibres are formed into staple fibre yarns by the spinning-knitting process, the staple fibre yarns comprising a twist factor having a spin alpha metric within a range from 0 to 2.

32: The support and reinforcing material according to claim 23, wherein the staple fibres are formed into staple fibre yarns by the spinning-knitting process, the staple fibre yarns comprising a twist factor having a spin alpha metric within a range from 0.05 to 1.

33: A composite material comprising:
a support and reinforcing material comprising a single-ply of a textile sheet material produced from staple fibre yarns, the staple fibre yarns comprising staple fibres twisted with a spin alpha metric within a range from 0 to 10; and
a rubber and/or plastic material bonded to the textile sheet material.

34: The composite material according to claim 33, wherein the textile sheet material and the rubber and/or plastic material are formed into a hose defining an interior passage.

35: The composite material according to claim 33, wherein the textile sheet material is a knitted fabric produced from staple fibres by a spinning-knitting process to comprise stitches that are formed of staple fibres having a spin alpha metric of zero.
